(19) United States
(12) Patent Application Publication
(10) Pub. No.: US 2014/0329426 A1
(43) Pub. Date: Nov. 6, 2014

(54) GLITTER FILM BACKING FOR ADHESIVE TAPES AND METHODS OF MAKING THE SAME

(71) Applicant: 3M INNOVATIVE PROPERTIES COMPANY, St. Paul, MN (US)

(72) Inventor: Richard L. Peloquin, Maplewood, MN (US)

(73) Assignee: 3M INNOVATIVE PROPERTIES COMPANY, St. Paul, MN (US)

(21) Appl. No.: 14/268,154

(22) Filed: May 2, 2014

Related U.S. Application Data
(60) Provisional application No. 61/819,241, filed on May 3, 2013.

(51) Int. Cl. C09J 11/04; C09J 7/02; C08K 3/10; B32B 27/20

(52) U.S. Cl. CPC C09J 11/04; B32B 27/20; C09J 7/0275; C08K 3/10; B32B 2264/105; C09J 2205/106; C09J 2423/006
USPC 442/1; 428/354; 428/323; 428/327; 428/500; 428/328; 524/437

(57) ABSTRACT

Film-based articles useful, for example, as the backing of an adhesive tape. The film-based article includes a film layer and a plurality of glitter particles. The glitter particles are disposed within the film layer and each has a melting point of not less than 135° C. In some embodiments, the top and bottom film layers are additionally provided along opposing major surfaces of the film layer, with the film layers each comprising a polyolefin-based resin. The articles are formed by a blown film extrusion process, and some or all of the glitter particles can have an elevated particle size, for example not less than 130 μm, alternatively not less than 240 μm.

### CROSS REFERENCE TO RELATED APPLICATIONS

This application claims priority to U.S. Provisional Application No. 61/819,241, filed May 3, 2013, the disclosure of which is incorporated by reference in its entirety herein.

### BACKGROUND

The present disclosure relates to film-based backings. More particularly, it relates to decorative, glitter-laden film backings useful, for example, with adhesive tapes including those commonly referred to as duct tape, and methods of making the same.

Duct tape is a common and widely used type of adhesive tape. Duct tape typically comprises a polymer film backing, a scrim, and an aggressive pressure sensitive adhesive that is coated over the scrim and the backing. The scrim provides the tape with a desired level of strength and allows the tape to be torn by hand.

Duct tape has historically been sold as a repair tape with the majority of tape constructions employing a gray/silver polyolefin film backing. This market is fairly commoditized with the exception of some specialty duct tapes that are transparent on/or formulated to limit adhesive residue. More recently, duct tape has been used as a crafting or decorative tape. The backings associated with these duct tapes can employ brightly colored or ink patterned films with specific designs.

New tape designs are continually being introduced to the tape crafting market to match current color and design trends. The use of glitter for crafting and decorating projects is very popular today with a wide segment of consumers. A number of glitter tapes are currently offered for sale in this market area. Most glitter decorative tape constructions consist of a pressure sensitive adhesive coated backing with the glitter applied to the top surface. These tapes typically have a release liner and are not hand tear-able. The glitter used for these available glitter tapes is metal vapor coated polyester that may be ink printed to produce various colors. The size of the glitter flake is approximately 200 μm that gives a noticeable sparkle effect. A major drawback with most top surface-applied glitter tape products is the unavoidable dislodgement and loss of some of the glitter flakes from the tape backing (e.g., during handling). The dislodged glitter flakes inevitably fall on to various surfaces, and requisite cleaning of the glitter flakes from the surface can be quite difficult. Moreover, top surface-applied glitter tape products can be quite expensive; for example, a currently-available 2 inch×4.4 yard (5.1 cm×4.0 m) roll of top surface-applied glitter tape retails for $6.99 as compared to a 2 inch×10 yard (5.1 cm×9.1 m) roll of pattern printed duct tape retailing at $3.99.

An alternative approach for producing a glitter tape construction is to flexographic or gravure print a glitter ink onto a backing substrate. These inks essentially consist of various color pigments and aluminum metallic flakes dispersed in the ink vehicle. While possibly viable, a drawback of flexographic or gravure ink printing is the inherent limit of the size of the metal flake that can be used in the ink printing process. The size of the metal flakes typically used with these ink formulation is on the order of 80-100 μm and does not provide the desired visual effect (as compared to the top surface-applied glitter tape products described above). Printing with a larger metal flake size will result in formation of undesirable, visible streaks in the resultant backing, along with inconsistent ink printing coverage. In addition, these specialty ink formulations are quite expensive and can easily double manufacturing costs of the final tape product.

In light of the above, a need exists for improved glitter-laden film articles, useful as backings for adhesive tapes such as duct tapes, and methods of manufacturing the same.

### SUMMARY

Some aspects of the present disclosure are directed toward adhesive tapes including a backing and a layer of adhesive. The backing defines opposing, first and second major faces and includes a first film layer and a plurality of glitter particles. The glitter particles are disposed with the first film layer and each of the glitter particles has a melting point of not less than 135° C. The layer of adhesive is disposed over the second major face. In some embodiments, the first film layer is an olefin-based polymer, and the glitter particles are encapsulated within the first film layer as part of a blown film extrusion process. In related embodiments, each of the glitter particles have a melting point well above the temperature associated with the blown film extrusion process, for example at least 160° C., and some or all of the glitter particles can have an elevated particle size (e.g., not less than 130 μm; alternatively not less than 240 μm). The backing optionally includes additional film layers disposed on the opposing major surfaces, respectively, of the first film layer, with the additional film layers formed from a polyolefin-based resin akin, optionally identical, to the polyolefin-based resin of the first (or middle) film layer. In related embodiments, the top film layer can be substantially transparent, and the bottom film layer can include a colorant. Regardless, the adhesive tapes of the present disclosure can optionally include a scrim disposed over the backing to provide a reinforced adhesive tape (e.g., duct tape).

Other aspects of the present disclosure relate to a film-based article. The film-based article can be useful in serving as a backing of an adhesive tape and includes a first-third film layers and a plurality of glitter particles. The second and third film layers are disposed along opposing major surfaces of the first film layer. The glitter particles are disposed within the first film layer, and each has a melting point of not less than 135° C. In some embodiments, the film-based article is created by a blown film extrusion process.

### BRIEF DESCRIPTION OF THE DRAWINGS

FIG. 1 is a simplified, cross-sectional view of a film-based article in accordance with principles of the present disclosure;

FIG. 2A is a simplified, cross-sectional view of another film-based article in accordance with principles of the present disclosure;

FIG. 2B is a simplified, cross-sectional view of another film-based article in accordance with principles of the present disclosure;

FIG. 3 is a schematic representation of a process for manufacturing articles of the present disclosure;

FIG. 4 is a simplified, cross-section view of an adhesive tape in accordance with principles of the present disclosure;

FIG. 5A is a micro-photograph of a sample film-based article in accordance with principles of the present disclosure;

FIG. 5B is a micro-photograph of a cross-section of the sample article of FIG. 5A;

FIG. 6 provides micro-photographs of sample film-based articles in accordance with principles of the present disclosure;

FIG. 7 provides micro-photographs of comparative example film articles including glitter particles; and

FIG. 8 is a micro-photograph of a cross-section of a comparative film article incorporating glitter particles.

### DETAILED DESCRIPTION

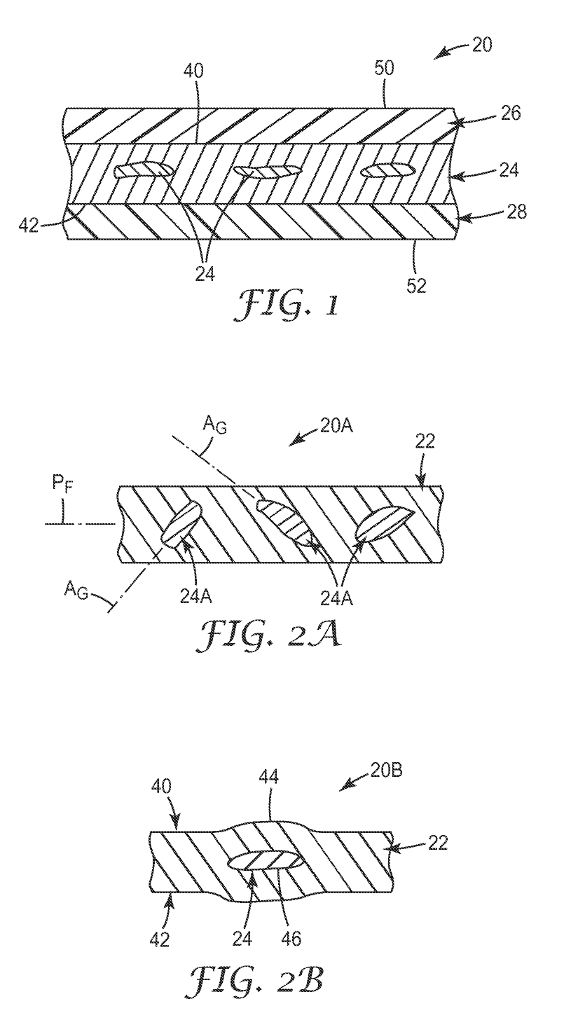

One embodiment of a film-based article 20 in accordance with principles of the present disclosure and useful, for example, as an adhesive tape backing, is shown in FIG. 1. The film-based article 20 includes a first film layer 22 and a plurality of glitter particles 24 encased within the first film layer 22. The film-based articles of the present disclosure can optionally include one or more additional film layers, such as a second film layer 26 and a third film layer 28. With these optional constructions, the first film layer 22 can be referred to as a middle or core film layer, the second film layer 26 as a top film layer, and the third film layer 28 as a bottom film layer for reasons made clear below. Regardless, and in general terms, the glitter particles 24 are embedded into the first film layer 22 during formation of the first film layer 22 with a blown film extrusion process (or other similar process), and are selected to have a melting point in excess of the elevated temperatures associated with this film fabrication technique. The film-based articles, and corresponding adhesive tapes, of the present disclosure can include larger-sized ones of the glitter particles 24 yet remain streak free, and are inexpensive to manufacture.

The first film layer 22 can be formed from a variety of polymer resins, and in some embodiments is a polymer resin amenable to blown film extrusion. The first film layer 22 is, in some embodiments, a polyolefin material. Polyolefin films are useful as backings for various adhesive tape end constructions, including reinforced adhesive tapes (e.g., duct tape), and are well-suited for blown film extrusion manufacture. In related embodiments, the first film layer 22 is substantially transparent (e.g., at least 90% transmission of light in the visible spectrum) so as to not overtly obscure the glitter particles 24 from an exterior of the film-based article 20. In some embodiments, the polyolefin material of the first film layer 22 is polyethylene-based, for example low density polyethylene, high density polyethylene, linear low density polyethylene, and their copolymers. Other non-limiting polyolefin materials useful as the first film layer 22 include polybutylene, polyisoprene, and their copolymers.

The glitter particles 24 can have a variety of different constructions (e.g., material, shape, size, etc.), and in more general terms each have a melting point of not less than 135° C., in some embodiments a melting point of not less than 160° C., and in yet other embodiments a melting point of not less than 185° C. In other embodiments, the minimum melting point of the glitter particles 24 is a function of the material(s) selected for the first film layer 22 (and the second and third film layers 26, 28 where provided); the melting point of each of the glitter particles 24 is greater than the melting point of the resin(s) employed for the film layers 22, 26, 28. As described in greater detail below, the elevated melting point of the glitter particles 24 promotes the manufacturing methods of the present disclosure.

In some embodiments, all of the glitter particles 24 provided with the film-based article are the same material (though may have other properties that differ such as shape, size, etc.). In other embodiments, a combination of two or more different types of the glitter particles 24 can be employed. Regardless, some useful materials for the glitter particles 24 include metals (e.g., aluminum, copper, silver, gold, brass, etc.). Alternatively or in addition, some or all of the glitter particles 24 can be a polymer film, including a vapor-coated polyester.

FIG. 1 illustrates the glitter particles 24 as optionally having a flake-like shape (e.g., a length dimension greater than or approximating a width dimension, and a thickness dimension significantly less than (for example at least 10 times less than) the length and width dimensions that generates a flat or flake-like shape). In other embodiments, however, some or all of the glitter particles 24 can be other shapes that are not flat or flake-like. For example, some or all of the glitter particles 24 can have a thickness that more closely approximates the corresponding length and width dimensions (e.g., within 50% of one or both of the length and width dimensions). In other words, the glitter particles 24 of the present disclosure are not limited to flat flakes. Uniform shapes (e.g., sphere-like) and compound shapes are equally acceptable.

Regardless of an exact shape, each of the glitter particles 24 defines a major or maximum dimension (e.g., with a flattened, flake-like shape, the glitter particle's major or maximum dimension is the length). With this in mind, at least some, and in some embodiments all, of the glitter particles 24 have a maximum dimension of not less than 130 μm, alternatively not less than 170 μm, and optionally on the order of 250 μm (+ or −15 μm). In other embodiments, some or all of the glitter particles 24 have a maximum dimension in the range of 170-250 μm.

As a point of reference, FIG. 1 illustrates the flake-like glitter particles 24 as being oriented in general alignment with a thickness of the first film layer 22 (e.g., the thickness of the glitter particles 24 is aligned with a thickness of the first film layer 22 such that the major axis of the glitter particles is parallel or substantially parallel (e.g., within 10% of a truly parallel relationship) to the major axis or plane of the first film layer 22). In accordance with principles of the present disclosure, however, some or all of the glitter particles 24 can be randomly oriented relative to the first film layer 22. For example, FIG. 2A illustrates an alternative embodiment film-based article 20A in accordance with principles of the present disclosure in which the glitter particles 24A are oriented to be out of alignment with the first film layer 22. Stated otherwise, the glitter particles 24A each define a major axis A_{G} and the first film layer 22 defines a major plane P_{F}; the major axis A_{G} is not parallel (or substantially parallel) to the major plane P_{F}.

Returning to FIG. 1, encasement of the glitter particles 24 within the first film layer 22 is described in greater detail below. Upon final construction, the first film layer 22 forms or defines opposing, first and second major surfaces 40, 42. The glitter particles 24 are contained within a thickness of the first film layer 22, between the first and second major surfaces 40, 42. It should be noted that for ease of illustration, FIG. 1 depicts an entirety of the major surfaces 40, 42 as being substantially flat. In actual practice, however, one or both of the major surface 40, 42 can bulge outwardly (generally perpendicular to the major plane P_{F} (FIG. 2A) defined by the first film layer 22) in a region of each of the glitter particles 24 in accommodating, or forming about, dimensions of the glitter particles 24. For example, FIG. 2B illustrates a portion of alternative film-based article 20B, and depicts bulges 44, 46 formed along the major surfaces 40, 42 of the first film layer 22 in response to presence of the glitter particle 24. A resultant caliper or overall thickness of the film-based article 20B (as well as other film-based articles provided by the present disclosure) is thus increased in a region of each of the glitter particles 24. Thus, with the film-based articles 20 (and corresponding adhesive tapes) of the present disclosure, the film-based article can exhibit a “roughened” feel along the exterior face(s) thereof.

As previously described, the film-based article 20 of FIG. 1 optionally includes one or both of the second and third film layers 26, 28. In general terms, the second film layer 26 is formed over the first major surface 40 of the first film layer 22, and the third film layer 28 is formed over the second major surface 42. With this construction, the second film layer 26 serves to define a first major face 50 of the article 20, whereas the third film layer 28 defines a second major face 52. With embodiments in which the film-based article 20 is employed as the backing of an adhesive tape (e.g., a reinforced adhesive tape such as duct tape), the second major face 52 is connected to an underlying structure (e.g., a scrim) such that the first major face 50 serves as an “outer” (i.e., visible) face of the resultant adhesive tape.

With the above explanations in mind, the second film layer 26 is formed from a polymer resin amenable to blown film extrusion manufacturing techniques and in some embodiments is a polyolefin material. Any of the materials described above for the first film layer 22 are equally acceptable for use with or as the second film layer 26 (e.g., the second film layer 26 can be any of the polyethylene-based materials described above). In some embodiments, the second film layer 26 is substantially transparent (e.g., at least 90% transmission of light in the visible spectrum). Alternatively, the second film layer 26 can include optional additives such as colorants. In yet other embodiments, additional glitter particles 24 can be encased within the second film layer 26.

The third film layer 28 is also formed from a polymer resin amenable to blown film manufacturing techniques and in some embodiments is a polyolefin-based material. Any of the materials described above for the first film layer 22 are equally acceptable for use with or as the third film layer 28 (e.g., the third film layer 28 can include any of the polyethylene-based materials described above). In some embodiments, the third film layer 28 includes one or more additives, such as a colorant, that renders the third film layer 28 to not be substantially transparent. In yet other embodiments, additional glitter particles 24 can be encased within the third film layer 28.

The first-third film layers 22, 26, 28 can be formed from the same polymer resin material or from different resin materials. For manufacturing efficiency (described below) it may be desirable to form the first-third film layers 22, 26, 28 from the same polymer resin. In other embodiments, the film-based articles (and corresponding adhesive tapes) can have four or more film layers.

As a point of reference, and as previously described, FIG. 1 depicts the opposing surfaces 40, 42 of the first film layer 22 as being relatively, entirely flat for ease of illustration. It will be understood, however, that the first film layer 22 will instead “bulge” in a region of the each of the glitter particles 24 (e.g., as shown in FIG. 2B). Under these circumstances, the second and third film layers 26, 28 may follow this same surface morphology such that the resultant film-based article 20 does not have the relatively uniform caliper or thickness as generally illustrated. Instead, the thickness of the article 20 can vary (e.g., is elevated) in a region of each of the glitter particles 24. With this in mind, a nominal thickness of each of the film layers 22, 26, 28 can be defined as a thickness of the corresponding film layer 22, 26, 28 apart from the glitter particles 24. In some embodiments, a nominal thickness of the first film layer 22 (or the film layer 22, 26, 28 otherwise carrying the glitter particles 24) is greater than a nominal thickness of the second and third film layers 26, 28 to accommodate the glitter particles 24. For example, in some embodiments, a layer ratio of the second/first/third film layers can be on the order of 1.0/2.3/1.0. An overall nominal thickness of the film-based article is at least about 25 μm (1 mil), alternatively at least about 0.58 mm (23 mils). With embodiments in which the article 20 is to be employed as a backing for a reinforced tape such as duct tape, the article 20 has an overall nominal thickness of not greater than 0.089 mm (3.5 mils) to provide hand-tearability. Other thicknesses are also acceptable.

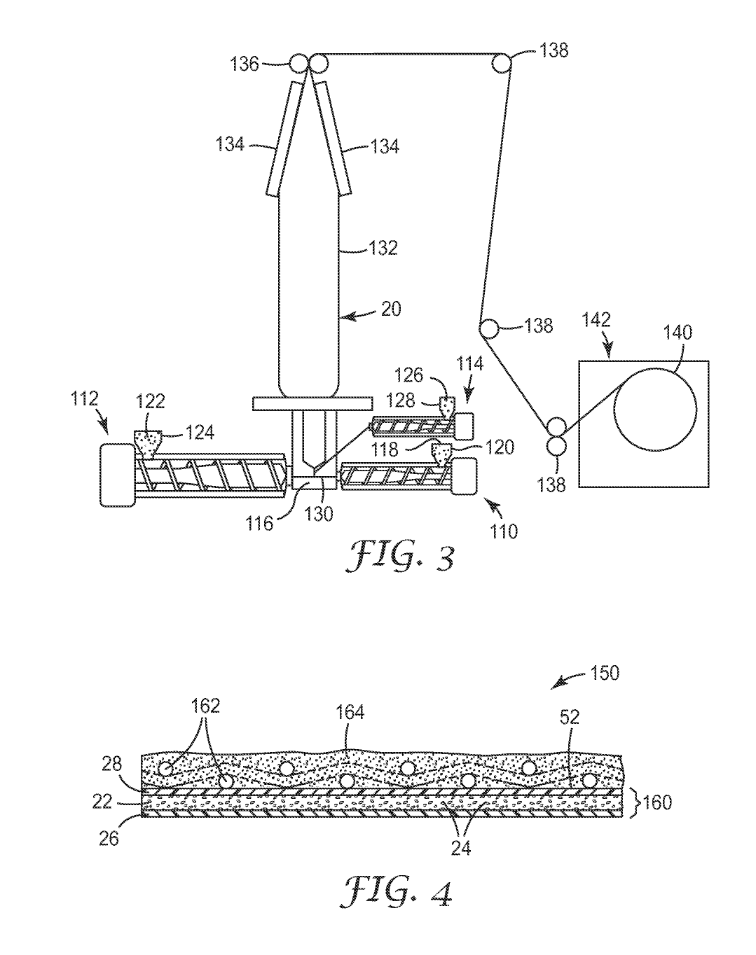

Methods of manufacturing the film-based articles in accordance with principles of the present disclosure generally entail a blown film extrusion process. Referring to FIG. 3, a schematic representation of a blown film extrusion process useful for producing the film-based articles of the present disclosure is shown. The blown film process includes three single screw extruders 110, 112, and 114 which simultaneously feed a three-layer extrusion die 116. With reference between FIGS. 1 and 3, the extruder 110 is loaded with a polymer composition 118 selected for the second film layer 26 through hopper 120. The extruder 112 is loaded with a polymer composition 122 selected for the first film layer 22 along with the glitter particles 24 through hopper 124. In some embodiments, the first film layer polymer resin composition 122 is fed into the hopper 124 as a dry resin to encourage mixing with the glitter particles 24. A ratio (by weight) of the glitter particles 24 relative to the first film layer composition 122 can vary, and in some embodiments is on the order of 5-25%. The extruder 114 is loaded with a polymer composition 126 selected for the third film layer 28 through hopper 128.

In operation, the extruders 110, 112, 114 simultaneously feed the polymer compositions 118, 122, 126 through runners 130 and into the three-layer extrusion die 116. The extrusion die 116 forms the film-based article 20 as an annular-shaped bubble 132 that is fed through a collapsing frame 134 and nip rollers 136 that act to collapse the annular bubble 132. The film-based article 20 is then fed through a series of rollers 138 and optionally wound into a roll 140 at a winder 142.

The blown film extrusion process described above can be varied as is known in the art, and can include more or less of the extruders/supply lines depending upon the number of film layers in the resultant article. For example, when the blown film extrusion process described above is used to prepare embodiments of film-based articles of the present disclosure incorporating only a single polymer composition, the blown film extrusion system is typically run by extruding all three layers using the same polymer. As compared to other conventionally employed polymer film manufacturing methods and equipment, however, the blown film extrusion methods and systems of the present disclosure have surprisingly been found to be well-suited for fabrication of the glitter-bearing articles disclosed herein. For example, the die gap associated with blown film extrusion dies is typically on the order of 1.0 mm (40 mils) and thus can readily accommodate the elevated glitter particle sizes of the present disclosure. In a blown film extrusion process the draw (or bubble size) from the die controls the film caliper. Conversely, the die gap associated with a cast film extrusion process is significantly less as compared to the die gap associated with a blown film extrusion for equal caliper films (at least 1:3), and the die gap controls the film caliper. A cast film extrusion die can have a gap size on the order of 0.38 mm (15 mils) or less, and cannot consistently prepare acceptable film-based articles or backings including glitter particles larger than 130 μm.

The glitter laden, film-based articles of the present disclosure have a variety of end use applications. For example, the film-based article 20 of FIG. 1 (or any other embodiment implicated by the present disclosure) can be employed as decorative item in and of itself. In other embodiments, the film-based articles of the present disclosure can serve as the backing of an adhesive tape. For example, an adhesive can be applied to one of the opposing major faces 50, 52 of the article, with the resultant structure serving as an adhesive tape. In yet other embodiments, the article 20 is used as the backing of a reinforced adhesive tape, such as duct tape. FIG. 4 illustrates one non-limiting example of a reinforced adhesive tape 150 in accordance with principles of the present disclosure, and includes a backing 160, a reinforcing material or scrim 162, and a layer of adhesive 164. The backing 160 can be any of the film-based articles 20 described above, and includes the glitter particles 24 as previously described. The scrim 162 and the adhesive 164 can assume any form typically employed for reinforced adhesive tapes.

The backing 160 may contain other optional additives and ingredients as is known in the art including, for example, fillers, pigments and other colorants, antiblocking agents, lubricants, plasticizers, processing aids, antistatic agents, nucleating agents, antioxidants and heat stabilizing agents, ultraviolet-light stabilizing agents, and other property modifiers.

In one embodiment, the second film layer 26 of the backing 160 in FIG. 4 may include a release agent. Release agents are often provided on the back surface (i.e., the surface opposite the adhesive surface) of an adhesive tape (e.g., duct tape) to allow the tape to be provided in roll form, and to allow the tape to be readily and conveniently dispensed by unwinding the roll. The particular release agent is not significant to the present disclosure, so long as it provides the desired function of allowing the adhesive tape to be provided in roll form, and allowing the adhesive tape to be readily and conveniently dispensed by unwinding the roll. The release agent may be provided as a coating on the exposed surface of the outer layer, or the release agent may be incorporated into the resin that forms the outer layer. It will be recognized that release agents incorporated into the resin tend to migrate to the surface of the surface of the outer layer, thereby forming a release coating on the exposed outer surface of the backing film. Suitable release agents and techniques for incorporating release agents into a release layer are described in U.S. Pat. No. 7,229,687 (Kinning, et al.), the entire contents of which are hereby incorporated by reference.

The particular scrim 162 selected is not significant to the present disclosure, so long as it provides the desired function of imparting the desired amount of strength to the tape 150, and allowing the tape 150 to be readily hand tearable in at least the cross-web direction. A variety of materials can be used to make the scrim 162 including natural materials, synthetic materials, and combinations thereof. Examples of natural materials include cotton, silk, hemp, flax, and combinations thereof. Examples of synthetic materials include polyester, acetate, acrylic, polyolefin (e.g., polyethylene and polypropylene), rayon, and nylon. Suitable scrims are described in, for example, U.S. Pat. No. 5,162,150 (Buis, et al.), U.S. Pat. No. 6,211,099 (Hutto, Jr.), U.S. Pat. No. 7,056,884 (Sheely), and U.S. Publication No. 2009/0155565 (Ulsh).

The particular adhesive 164 is arranged over the second major face 52 of the backing 160 and covers the scrim 162. The particular adhesive 164 selected is not significant to the present disclosure so long as it possesses the desired adhesive characteristics. A variety of adhesives can be used, including pressure sensitive adhesives typically used in duct tape constructions. Adhesive compositions useful for duct tape constructions of the present disclosure are described in, for example, U.S. Application Publication No. 2012/0028525, the entire teachings of which are hereby incorporated by reference.

Exemplary pressure sensitive adhesives include repositionable, removable and permanent adhesives. Representative examples of pressure sensitive adhesives useful in tapes of the present disclosure include those based on natural rubbers, synthetic rubbers, or acrylics. More particularly, the pressure sensitive adhesives contemplated for use may be selected from the group consisting of organic solvent based acrylics, waterborne acrylics, silicone adhesives, natural rubber based adhesives, and thermoplastic resin based adhesives.

In specific embodiments, the pressure sensitive adhesive 164 is coated by hot melt coating to the surface of the backing 160 over the scrim 162 at a coating weight of at least about 84 grams/m² (20 grains/24 sq. inches) and at a coating weight of no greater than about 357 grams/m² (85 grains/24 sq. inches).

Typically, the backing 160 and scrim 162 are brought into contact with one another and the pressure sensitive adhesive 164 is coated over the scrim 162 and backing 160. Alternatively, the scrim 162 may be pre-bonded to the backing 160, for example, using an adhesive or by heat laminating the scrim 162 to the backing 160. Suitable coating techniques for applying the pressure sensitive adhesive are well known to those of skill in the art and include, for example, calendaring (e.g., stripper roll calendaring), spraying, and die coating (e.g., slot die, drop die, or rotary rod die). In one embodiment, the pressure sensitive adhesive is applied as a 100% solids formulation that is heated to provide a coatable viscosity, for example, by contacting one or more heated rolls prior to being applied to the backing.

In order that principles of the present disclosure can be more fully understood, the following examples are set forth. It should be understood that these examples are for illustrative purposes only, and are not to be construed as limiting the present disclosure in any manner.

### EXAMPLE 1

Three layer film-based articles useful, for example, as backings in the preparation of adhesive tapes were prepared using a continuous blown film extrusion process as known in the art. The blown film extruder had a 6.4 cm (2.5 inches) diameter die with a 1.02 mm (0.0040 inch) gap that can extrude a film up to 27.9 cm (11 inches) in diameter. Four lots (Example Lots 1A-1D) of film-based articles each having three layer films (i.e., the top film layer 26, the middle film layer 22, and the bottom film layer 28 of FIG. 1) were prepared. With each lot, the collective film caliper was targeted at 0.076 mm (3.0 mils). A layer ratio of 1.0/2.3/1.0 was targeted, with the middle film layer 22 being thicker to accommodate glitter particles as described below. The film resin used for the three film layers of each Example Lot was low density polyethylene (LDPE) (PETROTHENE® NA217000 available from Equistar (LyondellBassell Industries) of Houston, Tex.). A colorant (Red CC10121545WE color concentrate available from PolyOne Corp. of Avon Lake, Ohio) was added to the resin of the bottom film layer at 4 wt % to provide film color.

Various types of glitter particles were incorporated into the middle film layer 22 of three of the four film lots (Example Lots A2-A4). In particular, no glitter particles were included with the first film lot Example Lot A1 (such that Example Lot A1 serves as a control). Aluminum metal flakes having a nominal size of 170 μm (PELLEX™ A170-30LW available from Nubiola of Norcross, Ga.) were included with the middle film layer of Example Lot A2 (8 wt % add level). Aluminum metal flakes having a nominal size of 240 μm (PELLEX™ A240-30LW available from Nubiola of Norcross, Ga.) were included with the middle film layer of Example Lot A2 (8 wt % add level). Finally, silver pigmented metal particles having a nominal size of 250 μm (SILVET® 730-30-E1 available from Siberline of Tamaqua, Pa.) were included with the middle film layer of Example Lot 1D (8 wt % add level). The components of the four sample film lots (Example Lots 1A-1D) of Example 1 are summarized in Table 1.

TABLE 1

| | | | | Film Caliper | |
|---|---|---|---|---|---|
| | | Flake | Add | mm | |
| | | Size | Level | (mils) | |
| Lot | Metallic Flake | μm | wt % | Flat | Point |
| Lot 1A | None | | | 0.094 | 0.086 |
| | | | | (3.7) | (3.4) |
| Lot 1B | PELLEX ™ A170-30LW | 170 | 8 | 0.091 | 0.046 |
| | | | | (3.6) | (1.8) |
| Lot 1C | PELLEX ™ A240-30LW | 240 | 8 | 0.081 | 0.041 |
| | | | | (3.2) | (1.6) |
| Lot 1D | SILVET ® 730-30-E1 | 250 | 8 | 0.086 | 0.038 |
| | | | | (3.4) | (1.5) |

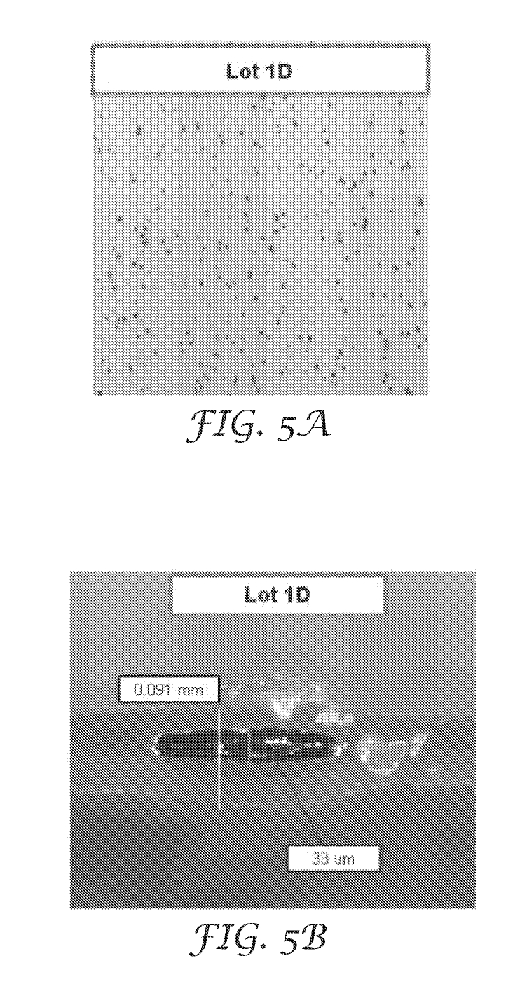

Each of the films of Example Lots 1A-1D were visually examined, and no streaking was found. For example, a top view micro-photograph of a sample from Example Lot 1D is provided in FIG. 5A. Film layer thickness profile measurements were made using a video microscope at a 2× magnification with a 0.127 mm stage micrometer. FIG. 5B provides a micro-photograph of a cross-section taken from the fourth sample lot, Example Lot 1D. The thickness of the metal particle was measured to be about 33 μm (0.0013 inch), whereas the total film thickness was measure to be about 0.083 mm (0.0033 inch).

It was observed that the each of the blown films with glitter particles (i.e., the metal flakes described above) was rough in texture. This was due to protrusion of the metal flake in the film as reflected by the micro-photograph of FIG. 5B. Cross-sectional measurements confirmed that the film caliper with the metal particle is nearly twice the thickness of the film surface without the metal particle. Film caliper was measured using an Ono Sokki EG-225 digital caliper gauge available from Ono Sokki Co., Ltd. The difference in film caliper measurements in tabulated in Table 1 that otherwise compares the film caliper measured using a flat surface probe (higher measurements) to the film caliper measured using a point surface probe (lower measurements) on the caliper gauge.

### EXAMPLE 2

Additional lots of three layer film-based articles useful as backings in the preparation of adhesive tapes were prepared using the continuous blown film extrusion process and equipment of Example 1. In particular, eight lots (Example Lots 2A-2H) of three layer film articles were prepared, with a target collective thickness of 0.102 mm (4.0 mils). The base resin used for all layers was the LDPE resin of Example 1. Various types of glitter particles were incorporated into the middle film layer 22 of seven of the lots (Example Lots 2B-2H) as highlighted in Table 2 below. Further, different colorants/concentrations were incorporated into one or more of the layers of several of the lots. In particular, Example Lots 2A-2C included 20 wt % gold colorant (Metal Gold CC10169285WE available from PolyOne Corp.) in the middle film layer 22 and 10 wt % white colorant (White CC10103772 available from PolyOne Corp.) in the bottom film layer 28. Example Lot 2D included 15 wt % silver colorant (Metal Silver CC10169284WE available from PolyOne Corp.) in the bottom film layer. Example Lot 2E included 10 wt % purple colorant (Plain Purple CC10169283WE available from PolyOne Corp.) in the bottom film layer. Example Lot 2F included 20 wt % purple colorant (Plain Purple CC10169283WE available from PolyOne Corp.) in the bottom film layer. Example Lot 2G included 10 wt % red colorant (Red CC10121545WE available from PolyOne Corp.) in the bottom film layer. Example Lot 2H included 40 wt % gold colorant (Metal Gold CC10169285WE available from PolyOne Corp.) in the bottom film layer. The top film layer 26 of Example Lots 2A-2H contained 1 wt % of a release agent. The components and measured thicknesses of the eight sample film lots (Example Lots 2A-2H) of Example 2 are summarized in Table 2.

TABLE 2

| | | | | Film Caliper | |
|---|---|---|---|---|---|
| | | Flake | Add | mm | |
| | | Size | Level | (mils) | |
| Lot | Metallic Flake | μm | wt % | Flat | Point |
| Lot 2A | None | | | 0.084 | 0.079 |
| | | | | (3.3) | (3.1) |
| Lot 2B | PELLEX ™ A170-30LW | 170 | 10 | 0.104 | 0.066 |
| | | | | (4.1) | (2.6) |
| Lot 2C | PELLEX ™ A240-30LW | 240 | 10 | 0.127 | 0.069 |
| | | | | (5.0) | (2.7) |
| Lot 2D | PELLEX ™ A240-30LW | 240 | 10 | 0.163 | 0.089 |
| | | | | (6.4) | (3.5) |
| Lot 2E | PELLEX ™ A240-30LW | 240 | 10 | 0.127 | 0.066 |
| | | | | (5.0) | (2.6) |
| Lot 2F | PELLEX ™ A240-30LW | 240 | 10 | 0.135 | 0.069 |
| | | | | (5.3) | (2.7) |
| Lot 2G | PELLEX ™ A240-30LW | 240 | 10 | 0.127 | 0.076 |
| | | | | (5.0) | (3.0) |
| Lot 2H | PELLEX ™ A240-30LW | 240 | 10 | 0.145 | 0.084 |
| | | | | (5.7) | (3.3) |

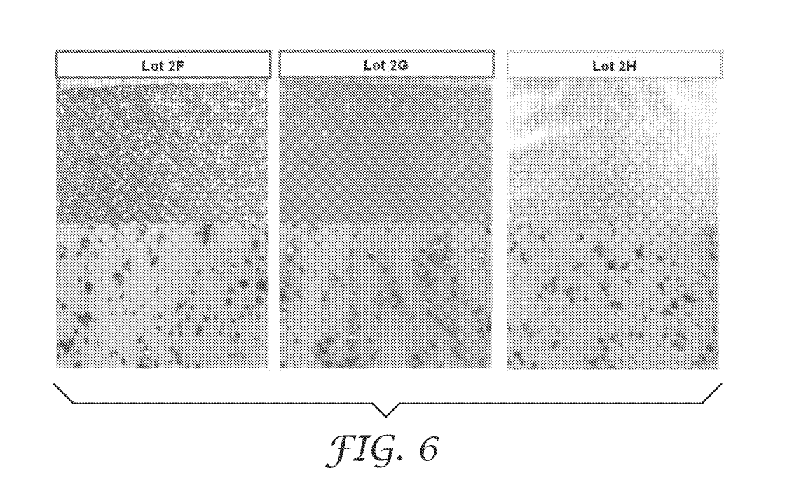

Each of the films of Example Lots 2A-2H were visually examined, and no streaking was found confirming that the methods of the present disclosure are capable of producing a streak free film-based article containing larger glitter particles/metal flakes (240 μm) at a 10 wt % additive level. Sample micro-photographs of the Example Lots 2F-2H are provided in FIG. 6.

With additional, general reference to FIG. 4, adhesive tapes were prepared using the film-based articles of Example Lots 2A-2H. To prepare the adhesive tape samples, the backing 160 (i.e., the Example Lot film sample) and the scrim 162 were brought into contact with one another with the scrim 162 contacting the bottom film layer 28 of the backing/Example Lot film sample. An elastomer pressure sensitive adhesive was then hot melt coated over the scrim and the backing/Example Lot film sample at a coating weight of 105 grams/m² (25 grains/24 sq. inches) using a hot melt coater to produce a reinforced tape (duct tape). The pressure sensitive adhesive composition was comprised of 48% isoprene block copolymer elastomer (available from Kraton Polymers of Houston, Tex.), 44% hydrocarbon tackifying resin (SUKOREZ® SU-400 available from Kolon Industries of Korea), 4% liquid hydrocarbon tackifying resin (ESCOREZ™ 2520 available from Exxon Mobil Chemical Company of Houston, Tex.), 2% titanium dioxide (available from Kronos Inc. of Dallas, Tex.), and 2% heat stabilizer (IRGANOX® available from BASF Chemical Company of Florham Park, N.J.). The scrim was a 100% polyester fiber scrim in a multi-filament configuration fiber counts 25 times 7, 70×150 denier (available from Milliken & Co. of Spartanburg, S.C.). Conventional hand-tearability tests were performed on the resultant reinforced tapes and confirmed that all samples exhibited acceptable hand-tear properties.

### EXAMPLE 3

Additional lots of three layer film-based articles in accordance with principles of the present disclosure were prepared using a blown film extrusion line having a 10.2 cm (4 inches) diameter die with a 0.157 mm (0.0062 inch) gap (capable of extruding a film up to 43.2 cm (17 inches) in diameter). The target film caliper for Example 3 was 0.114 mm (4.5 mils). Three different lots (Example Lots 3A-3C) were prepared using differing glitter particles. The base resin for each of the film layers was the LDPE resin of Example 1. Colorants of silver and purple (Metal Silver CC10169284WE and CC10169283WE available from PolyOne Corp.) were incorporated into the bottom film layer 28 of each of the Example Lots 3A-3C. The components and measured thicknesses of the three sample film lots (Example Lots 3A-3C) of Example 3 are summarized in Table 3.

TABLE 3

| | | | | Film Caliper | |
|---|---|---|---|---|---|
| | | Flake | Add | mm | |
| | | Size | Level | (mils) | |
| Lot# | Metallic Flake | μm | wt % | Flat | Point |
| Lot 3A | PELLEX ™ A170-30LW | 170 | 10 | 0.264 | 0.109 |
| | | | | (10.4) | (4.3) |
| Lot 3B | PELLEX ™ A240-30LW | 240 | 10 | 0.259 | 0.114 |
| | | | | (10.2) | (4.5) |
| Lot 3C | PELLEX ™ A240-30LW | 240 | 10 | 0.267 | 0.140 |
| | | | | (10.5) | (5.5) |

Each of the films of Example Lots 3A-3C were visually examined, and no streaking was found confirming that the methods of the present disclosure are capable of producing a streak free film-based article containing larger glitter particles/metal flakes (240 μm) at a 10 wt % additive level. The measured film caliper was about 0.254 mm (10 mils) using a flat surface probe caliper gauge, whereas film caliper was measured at about 0.114 mm (4.5 mils) with a point surface probe type caliper gauge.

The film-based articles of Example Lots 3A-3C were then adhesive coated as described in Example 2 to produce reinforce tape (duct tape). Conventional hand-tearability tests were performed on the resultant reinforced tapes and confirmed that all samples exhibited acceptable hand-tear properties. It was noted that the adhesive tapes of Example 3 were more difficult to tear than the adhesive tapes of Example 2 due to the increased film caliper.

### COMPARATIVE EXAMPLE

Three layer film-based articles carrying glitter articles were prepared using a cast film co-extrusion line having a 15.2 mm (6 inches) flat casting die. The die gap was set at about 0.152 mm (6 mils). In particular, six lots (Comp Lots 1-6) of film articles were prepared, each consisting of three film layers (top film layer 26, middle film layer 22 and bottom film layer 28). The polymer resin used for each of the film layers of the lots was the LDPE resin of Example 1. In addition, varying types of glitter particles were incorporated into the middle layer 22 of each of the Comp Lots as described below. A layer ratio of 1.0/2.3/1.0 was targeted. A 5 wt % red colorant (Red CC10121545WE available from PolyOne Corp.) was added to the bottom layer 28 of each of the Comp Lots. The components and measured thicknesses of the six sample film lots (Comp Lots 1-6) of the Comparative Example are summarized in Table 4.

TABLE 4

| | | | | Film |
|---|---|---|---|---|
| | | | | Caliper |
| | | | Add | Flat |
| | | Flake Size | Level | mm |
| Lot# | Metallic Flake | μm | wt % | (mils) |
| Comp Lot 1 | PELLEX ™ A135-30LW | 135 | 3 | 0.069 |
| | | | | (2.7) |
| Comp Lot 2 | PELLEX ™ A135-30LW | 135 | 5 | 0.071 |
| | | | | (2.8) |
| Comp Lot 3 | PELLEX ™ A170-30LW | 170 | 3 | 0.076 |
| | | | | (3.0) |
| Comp Lot 4 | PELLEX ™ A170-30LW | 170 | 5 | 0.071 |
| | | | | (2.8) |
| Comp Lot 5 | PELLEX ™ A170-30LW | 170 | 9 | 0.084 |
| | | | | (3.3) |
| Comp Lot 6 | PELLEX ™ A240-30LW | 240 | 3 | 0.081 |
| | | | | (3.2) |

Visual inspection of the film articles of Comp Lots 1-6 revealed that visible streaking did not occur with Lots incorporating 135 μm and 170 μm glitter particles (i.e., Comp Lots 1-5). However, with larger glitter particle size of 240 μm (Comp Lot 6), visual streaking occurred as shown by the micro-photographs of FIG. 7 (that otherwise provides a comparison of the film articles of Comp Lots 3 and 6). It is surmised that the streaking was due to the hold-up of the metal flake particles at the constricted extrusion die lip.

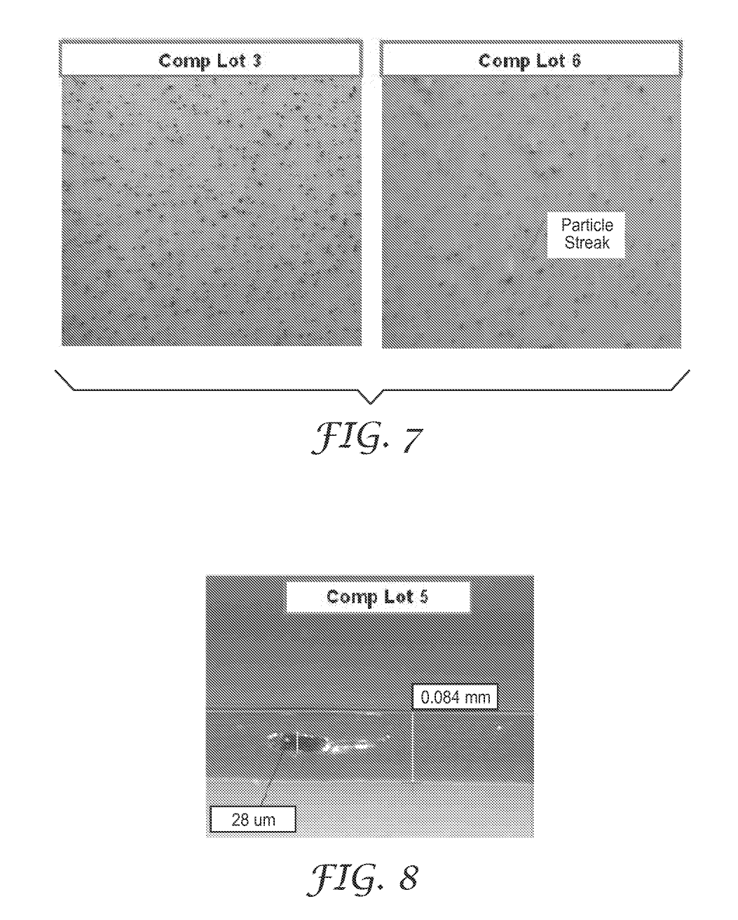

Film layer thickness profile measurements where made using a video capture microscope at 2× magnification with a 0.127 mm stage micrometer. The metal flake particles contained in the middle layer are shown in the cross-section micro photograph of FIG. 8 (Comp Lot 5). The thickness of the metal particle was measured to be about 28 μm (0.0011 inch) whereas the total film thickness was measured at about 0.084 mm (0.0033 inch). The outer faces of the film articles were found to be smooth or flat.

Although the present disclosure has been described with reference to preferred embodiments, workers skilled in the art will recognize that changes can be made in form and detail without departing from the spirit and scope of the present disclosure.

What is claimed is:

1. An adhesive tape comprising:
a backing defining opposing, first and second major faces, the backing including:
a first film layer,
a plurality of glitter particles disposed within the first film layer, wherein each of the glitter particles has a melting point of not less than 135° C.; and
a layer of adhesive disposed over the second major face.

2. The adhesive tape of claim 1, wherein the first film layer is substantially transparent.

3. The adhesive tape of claim 1, wherein the first film layer is an olefin-based polymer.

4. The adhesive tape of claim 1, wherein the first film layer is a polyethylene-based material.

5. The adhesive tape of claim 1, wherein the plurality of glitter particles are encased within the first film layer.

6. The adhesive tape of claim 1, wherein at least some of the glitter particles have an average particle size of not less than 130 μm.

7. The adhesive tape of claim 1, wherein the plurality of glitter particles includes metal flakes.

8. The adhesive tape of claim 1, wherein the plurality of glitter particles includes polymeric flakes.

9. The adhesive tape of claim 1, wherein the first film layer defines opposing, first and second major surfaces, and wherein the backing further includes:
a second film layer disposed over the first major surface.

10. The adhesive tape of claim 9, wherein the second film layer is an olefin-based polymer.

11. The adhesive tape of claim 9, wherein the second film layer is substantially transparent.

12. The adhesive tape of claim 9, wherein the backing further includes:
a third film layer disposed over the second major surface.

13. The adhesive tape of claim 1, further comprising:
a scrim;
wherein the adhesive is coated over the scrim.

14. The adhesive tape of claim 1, wherein the backing is created by a blown film extrusion process.

15. The adhesive tape of claim 1, wherein the adhesive tape is elongated defining opposing, front and back sides, the glitter particles being visible through the front side and the adhesive being exposed at the back side, and further wherein the adhesive tape is formed as a roll having successive wound layers, the adhesive of the back side of an outer most wound layer in direct contact with the front side of a successively next wound layer.

16. A film-based article comprising:
a first film layer defining opposing, first and second major surfaces;
a plurality of glitter particles disposed within the first film layer, wherein each of the glitter particles has a melting point of not less than 135° C.

17. The article of claim 16, further comprising:
a second film layer disposed over the first major surface; and
a third film layer disposed over the second major surface.

18. The article of claim 17, wherein each of the first, second and third film layers are an olefin-based polymer.

19. The article of claim 17, wherein the article is created by a blown film extrusion process.

20. The article of claim 16, wherein the article is configured to be bonded to a scrim in forming a reinforced adhesive tape.
